(19) United States
(12) Patent Application Publication
(10) Pub. No.: US 2021/0344092 A1
(43) Pub. Date: Nov. 4, 2021

(54) RESONATOR, FILTER, AND COMMUNICATION DEVICE

(71) Applicant: KYOCERA Corporation, Kyoto-shi, Kyoto (JP)

(72) Inventors: Hiromichi YOSHIKAWA, Yokohama-shi, Kanagawa (JP); Koji HAMADA, Yasu-shi, Shiga (JP)

(21) Appl. No.: 17/274,314

(22) PCT Filed: Sep. 9, 2019
(86) PCT No.: PCT/JP2019/035375

§ 371 Date: Mar. 8, 2021

(30) Foreign Application Priority Data
Sep. 12, 2018 (JP) 2018-170934

(51) Int. Cl. H01P 1/207; H01P 7/06

(52) U.S. Cl. CPC H01P 1/207; H01P 7/06

(57) ABSTRACT

A resonator includes: a shield housing; a first resonant element; and a second resonant element. The shield housing includes a first conductor portion located on a side of −Z direction and a second conductor portion located on a side of +Z direction, and has a cavity therein. The first resonant element has a columnar shape, lies within the cavity, and includes an end in the −Z direction joined to the first conductor portion and an end in the +Z direction spaced from the shield housing. The second resonant element in tubular dielectric form lies within the cavity, includes an end in the +Z direction joined to the second conductor portion and an end in the −Z direction spaced from the shield housing, and surrounds the first resonant element at a distance therefrom.

### TECHNICAL FIELD

The present invention relates to a resonator, and a filter and a communication device using the same.

### BACKGROUND ART

A resonator including a columnar conductor, which is connected to the ground at one end thereof, received in a shield case is known (refer to Patent Literature 1, for example). Also, a resonator including a columnar dielectric received in a shield case is known (refer to Patent Literature 2, for example).

### CITATION LIST

### Patent Literature

Patent Literature 1: Japanese Unexamined Patent Publication JP-A 2011-35792

Patent Literature 2: Japanese Unexamined Utility Model Publication JP-U 63-159904 (1988)

### SUMMARY OF INVENTION

A resonator according to the present disclosure includes:
a shield housing including a first conductor portion located on a first direction side, and a second conductor portion located on a second direction side which is opposite to the first direction side, the shield housing having a cavity therein;
a first resonant element which is shaped in a column and lies within the cavity, the first resonant element including a first direction end joined to the first conductor portion, and a second direction end spaced from the shield housing;
a second resonant element which is constituted by a tubular dielectric and lies within the cavity, the second resonant element including a second direction end joined to the second conductor portion and a first direction end spaced from the shield housing, and surrounding the first resonant element at a distance from the first resonant element; and
an inner wall-covering layer formed of a conductor, the inner wall-covering layer being located on an inner wall surface of the second resonant element.

A filter according to the disclosure includes:
first and second resonators, each comprising the resonator mentioned above;
a first terminal portion electrically or electromagnetically connected to the first resonator; and
a second terminal portion electrically or electromagnetically connected to the second resonator.

A communication device according to the disclosure includes: an antenna; a communication circuit; and the filter mentioned above connected to the antenna and the communication circuit.

### Advantageous Effects of Invention

The disclosure can obtain a compact resonator having excellent electrical characteristics. The disclosure can obtain a compact filter having excellent electrical characteristics. The disclosure can obtain a compact communication device having excellent communication quality.

### BRIEF DESCRIPTION OF DRAWINGS

Other and further objects, features, and advantages of the invention will be more explicit from the following detailed description taken with reference to the drawings wherein:

FIG. 1 is a sectional view schematically showing a resonator according to a first embodiment of the invention;

FIG. 2 is a view of a section along the line II-II of FIG. 1;

FIG. 3 is a perspective view showing a numerical analytical model for simulation of the resonator according to the first embodiment;

FIG. 4A is a view showing an electric field distribution obtained from analysis on the numerical analytical model for simulation of the resonator according to the first embodiment;

FIG. 4B is a view showing a magnetic field distribution obtained from analysis on the numerical analytical model of the resonator according to the first embodiment;

FIG. 5A is a view showing an electric field distribution obtained from numerical analysis of the electric field-magnetic field characteristics of a numerical analytical model for simulation of a resonator according to Comparative example 1 intended to represent a covered conductor-free resonator including a second resonant element 12 with an inner wall-covering layer 3 and an end wall-covering layer 4 removed;

FIG. 5B is a view showing a magnetic field distribution obtained from numerical analysis of the electric field-magnetic field characteristics of the numerical analytical model of the resonator according to Comparative example 1;

FIG. 6A is a view showing an electric field distribution obtained from numerical analysis of the electric field-magnetic field characteristics of a numerical analytical model for simulation of a resonator according to Comparative example 2 intended to represent a resonator including the second resonant element 12 whose dielectric is air, and which includes the inner wall-covering layer 3 on the inner surface thereof;

FIG. 6B is a view showing a magnetic field distribution obtained from numerical analysis of the electric field-magnetic field characteristics of the numerical analytical model of the resonator according to Comparative example 2;

FIG. 7A is a view showing an electric field distribution obtained from numerical analysis of the electric field-magnetic field characteristics of a numerical analytical model for simulation of a resonator according to Comparative example 3 intended to represent a resonator including the second resonant element 12 whose dielectric is a metal, with the inner wall-covering layer 3 and the end wall-covering layer 4 removed;

FIG. 7B is a view showing a magnetic field distribution obtained from numerical analysis of the electric field-magnetic field characteristics of the numerical analytical model of the resonator according to Comparative example 3;

FIG. 8 is a sectional view schematically showing a resonator according to a second embodiment of the invention;

FIG. 9A is a view showing an electric field distribution obtained from analysis on a numerical analytical model for simulation of the resonator according to the second embodiment;

FIG. 9B is a view showing a magnetic field distribution obtained from analysis on the numerical analytical model of the resonator according to the second embodiment;

FIG. 10 is a sectional view schematically showing a resonator according to a third embodiment of the invention;

FIG. 11 is a sectional view schematically showing a resonator according to a fourth embodiment of the invention;

FIG. 12 is a view showing a magnetic field distribution obtained from analysis on a numerical analytical model for simulation of the resonator according to the fourth embodiment;

FIG. 13 is a sectional view schematically showing a resonator according to a fifth embodiment of the invention;

FIG. 14 is a view showing a magnetic field distribution obtained from analysis on a numerical analytical model for simulation of the resonator according to the fifth embodiment;

FIG. 15 is a sectional view schematically showing a resonator according to a sixth embodiment of the invention;

FIG. 16 is a sectional view schematically showing a resonator according to a seventh embodiment of the invention;

FIG. 17 is a sectional view schematically showing a resonator according to an eighth embodiment of the invention;

FIG. 18 is a sectional view schematically showing a resonator according to a ninth embodiment of the invention;

FIG. 19 is a sectional view schematically showing a resonator according to a tenth embodiment of the invention;

FIG. 20A is a sectional view schematically showing a resonator free of a frequency adjuster 9;

FIG. 20B is a view showing a condition where the frequency adjuster 9 protrudes by 2 mm into a cavity 19 from a second conductor portion 14;

FIG. 20C is a view showing a condition where the frequency adjuster 9 protrudes by 4 mm into the cavity 19 from the second conductor portion 14;

FIG. 21 is a sectional view schematically showing a resonator according to an eleventh embodiment of the invention;

FIG. 22 is a perspective view schematically showing one embodiment of a filter according to the invention;

FIG. 23 is a sectional view of the filter shown in FIG. 22;

FIG. 24 is a graph indicating the frequency characteristics of the filter; and

FIG. 25 is a block diagram schematically showing one embodiment of a communication device according to the invention.

### DESCRIPTION OF EMBODIMENTS

A resonator, a filter, and a communication device according to the invention will now be described in detail with reference to the drawings.

### First Embodiment

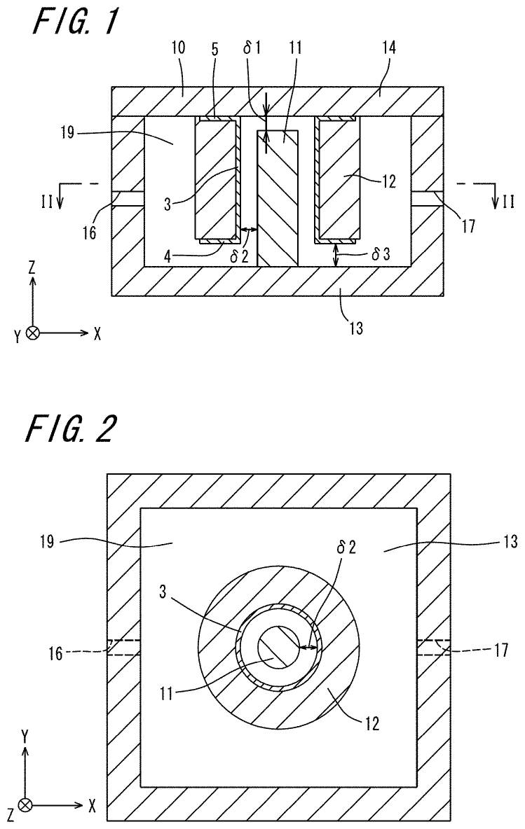

FIG. 1 is a sectional view schematically showing a resonator according to a first embodiment of the invention. FIG. 2 is a view of a section along the line II-II of FIG. 1. The resonator will hereafter be described on an X-Y-Z orthogonal coordinate basis.

The resonator according to this embodiment includes a shield housing 10, a first resonant element 11, and a second resonant element 12. The shield housing 10 includes a first conductor portion 13 and a second conductor portion 14. The first resonant element 11 may be made of a variety of heretofore known electroconductive materials, including metals and non-metallic electroconductive substances. In order to improve the characteristics of the resonator, an electroconductive material predominantly composed of Ag or an Ag alloy such as a Ag—Pd alloy or a Ag—Pt alloy; an electroconductive Cu-based material; an electroconductive W-based material, an electroconductive Mo-based material, or an electroconductive Pd-based material may be used.

The shield housing 10, in the form of a rectangular parallelepiped box which has a cavity 19 therein, is connected to a reference potential. The reference potential is called “ground potential” or “earth potential”, or also “grounding potential”. The shield housing 10 is constituted by joining the first conductor portion 13 and the second conductor portion 14 together via an electroconductive joining material. The first conductor portion 13 is located on a side of −Z direction which is a first direction (lower side as viewed in FIG. 1), and the second conductor portion 14 is located on a side of +Z direction which is a second direction (upper side as viewed in FIG. 1). The first conductor portion 13 includes four side walls and a bottom part, or equivalently has the form of a rectangular parallelepiped box which opens in the +Z direction. The second conductor portion 14 is shaped in a rectangular flat plate. Moreover, two side walls of the first conductor portion 13 arranged facing each other are provided with a through hole 16 and a through hole 17, respectively, for connection with an external circuit.

The first conductor portion 13 and the second conductor portion 14 may be made of a variety of known electroconductive materials, including metals and non-metallic electroconductive substances. In order to improve the characteristics of the resonator, an electroconductive material predominantly composed of Ag or an Ag alloy such as a Ag—Pd alloy or a Ag—Pt alloy; an electroconductive Cu-based material; an electroconductive W-based material, an electroconductive Mo-based material, or an electroconductive Pd-based material may be used.

A variety of known electroconductive joining materials, including solder and an electroconductive adhesive, may be used as the electroconductive joining material for joining the first conductor portion 13 and the second conductor portion 14 together. In some cases, the first conductor portion 13 and the second conductor portion 14 may be screw- or bolt-fastened to each other. Moreover, while the cavity 19 is filled with air, a vacuum may be created therein, or the cavity 19 may be filled with other gaseous substance than air, e.g. an inert gas.

The first resonant element 11, which lies at the center of the cavity 19 in a plan view as shown in FIG. 2, is shaped in a circular cylinder extending in ±Z direction. Moreover, the first resonant element 11 is joined, at an end in the −Z direction which is the first direction, to the first conductor portion 13 via an electroconductive joining material. A distance 51 is provided between an end of the first resonant element 11 in the +Z direction which is the second direction and the second conductor portion 14 of the shield housing 10. That is, the entire surface of the end of the first resonant element 11 in the −Z direction is bonded to the bottom part of the first conductor portion 13, and, the surface of the end of the first resonant element 11 in the +Z direction and the second conductor portion 14 of the shield housing 10 are spaced apart by the distance δ1.

In this embodiment, the first resonant element 11 is constituted by a conductor, and the resonator according to this embodiment serves as a resonator having a resonant mode analogous to TEM mode.

In this embodiment, the first resonant element 11 may be made of a variety of known electroconductive materials, including metals and non-metallic electroconductive substances. In order to improve the characteristics of the resonator, an electroconductive material predominantly composed of Ag or an alloy of Ag such as a Ag—Pd alloy or a Ag—Pt alloy; an electroconductive Cu material; an electroconductive W material, an electroconductive Mo material, and an electroconductive Pd material may be suitably selected and used. The first resonant element 11 may be formed of a columnar dielectric or insulator on a surface of which an electroconductive layer is provided. The first resonant element 11 may also be made of a resin material such as epoxy resin coated with a conductor layer.

The second resonant element 12 lies at the center of the cavity 19 coaxially with the first resonant element 11, and is shaped in a circular cylinder extending in the ±Z direction. The first resonant element 11 lies at the center of the interior of the second resonant element 12. That is, the second resonant element 12 is radially outwardly spaced from the first resonant element 11 by a distance δ2 so as to surround the first resonant element 11. Moreover, the second resonant element 12 is joined, at an end in the +Z direction which is the second direction, to the second conductor portion 14 via an electroconductive joining material. A distance δ3 is provided between an end of the second resonant element 12 in the −Z direction and the shield housing 10. That is, the entire surface of the end of the second resonant element 12 in the +Z direction is bonded to the second conductor portion 14, and the surface of the end of the second resonant element 12 in the −Z direction and the first conductor portion 13 of the shield housing 10 are spaced apart by the distance δ3.

The length of the first resonant element 11 in the +Z direction may be set at a value equal to or above 80% of the dimension of the cavity 19 in the +Z direction, or a value equal to or more than 90% of the dimension of the cavity 19 in the +Z direction. Moreover, one-half or more than one-half the total part of the first resonant element 11 in the +Z direction may be surrounded by the second resonant element 12. The ratio of the length of a part of the first resonant element 11 surrounded by the second resonant element 12 in the +Z direction to the total length of the first resonant element 11 in the +Z direction may be set at 50% or more. The above-described ratio may be set at 80% or more in the interest of electrical characteristic improvement, or more preferably set at 90% or more for further electrical characteristic improvement. This is grounded upon the utilization of even and odd modes for coupling between the first resonant element 11 and the second resonant element 12 in accordance with the principle of resonant mode concerned. In this case, the greater the ratio of the length in the +Z direction, the stronger the coupling in the even and odd modes, thus causing the even and odd-mode resonant frequencies to be apart. At this time, further decrease in frequency can be achieved by adjustment of the volume of the dielectric constituting the second resonant element 12. Moreover, magnetic field concentration on the first resonant element 11 can be reduced by adjustment of the dielectric of the second resonant element 12, thus allowing a magnetic field to spread to the second resonant element 12. This can improve a Q value. Thus, as a matter of importance, the ratio of the length in the +Z direction needs to be set at a reasonably large value. The dimensions of the cavity 19, the diameter of the first resonant element 11, the distance 52 between the first resonant element 11 and the second resonant element 12, and the thickness of the second resonant element 12 are determined properly in conformity with the desired size, the resonant frequency of fundamental-mode resonance, and the resonant frequency of higher order-mode resonance.

As a material of the second resonant element 12, known dielectric materials including dielectric ceramics may be used. For example, a dielectric ceramic material containing BaTiO₃, Pb₄Fe₂Nb₂O₁₂, TiO₂, etc. may be preferably used. In some cases, a resin such as epoxy resin may be used. A variety of known electroconductive joining materials, including an electroconductive adhesive, may be used as the electroconductive joining material for joining the second resonant element 12 and the shield housing 10 together.

Such a second resonant element 12 includes: a conductor-made inner wall-covering layer 3 located on an inner wall surface thereof; a conductor-made end wall-covering layer 4 located on an end in the −Z direction which is the first direction; and a conductor-made junction end-covering layer 5 located on an end in the +Z direction which is the second direction. The materials of construction of the inner wall-covering layer 3, the end wall-covering layer 4, and the junction end-covering layer 5 may be suitably selected and used from materials similar to those used for the first resonant element 11, namely an electroconductive material predominantly composed of Ag or an Ag alloy such as a Ag—Pd alloy or a Ag—Pt alloy; an electroconductive Cu-based material; an electroconductive W-based material, an electroconductive Mo-based material, and an electroconductive Pd-based material. For example, these layers are each made in the form of a 5 to 20 μm-thick electroconductive film through a metallization process. The lower limit of the film thickness has to be greater than a thickness value set for a skin effect corresponding to a frequency in use. The junction end-covering layer 5 may be joined to the shield housing 10 via solder, for example. In this case, the junction end-covering layer 5 and the solder serve as the electroconductive joining material.

The resonator according to this embodiment includes: the shield housing 10; the first resonant element 11; and the second resonant element 12. The shield housing 10 includes: the first conductor portion 13 located on the −Z direction side; and the second conductor portion 14 located on the +Z direction side which is opposite to the −Z direction side. Moreover, the shield housing 10 has the cavity 19 therein. The first resonant element 11 is formed of a conductor, has a columnar shape, and lies within the cavity 19, and an end of the first resonant element 11 in the −Z direction is joined to the first conductor portion 13, and the distance is provided between the other end of the first resonant element 11 in the +Z direction and the shield housing 10. The second resonant element 12 lies within the cavity 19, an end of the second resonant element 12 in the +Z direction is joined to the second conductor portion 14, and the distance is provided between the other end of the second resonant element 12 in the −Z direction and the shield housing 10, and the second resonant element 12 surrounds the first resonant element 11 at a distance therefrom. Thus constructed, the resonator according to this embodiment serves as a resonator having a resonant mode analogous to TEM mode.

Difficulties have been experienced in downsizing resonators from the related art as described in Patent Literature 1, for example. For cases where size reduction is achieved by setting a dielectric so as to fill up the interior of the shield case, the resonant frequency of higher order-mode resonance is greatly decreased to a level proximate to the resonant frequency of fundamental-mode resonance, which results in poor electrical characteristics. Furthermore, for cases where size reduction is achieved by placing a dielectric between the open end of the columnar conductor serving as the first resonant element and the shield case, the Q value is greatly decreased, which results in poor electrical characteristics.

As contrasted to such a resonator from the related art, the resonator according to this embodiment can have smaller size compared to a resonator from the related art as described in Patent Literature 1, etc., can suppress a decrease in the resonant frequency of higher order-mode resonance compared to a resonator from the related art as described in Patent Literature 1, etc., configured so that a dielectric is set so as to fill up the interior of the shield case, and can suppress a decrease in the Q value compared to a resonator from the related art as described in Patent Literature 1, etc., configured so that a dielectric is interposed between the open end of the columnar conductor and the shield case. That is, the resonator according to this embodiment has excellent electrical characteristics accruing from an appreciable difference between the resonant frequency of fundamental-mode resonance and the resonant frequency of higher order-mode resonance, and a high Q value. In addition to that, the resonator has small size. In short, the resonator according to this embodiment is compact yet excels in electrical characteristics.

Moreover, the thereby constructed resonator according to this embodiment is produced by following the steps below in the order presented: forming a unitary structure by bonding the end of the first resonant element 11 in the −Z direction to the first conductor portion 13; forming another unitary structure by bonding the end of the second resonant element 12 in the +Z direction to the second conductor portion 14; and joining the first conductor portion 13 and the second conductor portion 14 in a manner such that the first resonant element 11 is located inside the second resonant element 12. This procedure permits easy manufacture of the highly reliable resonator in which the end of the first resonant element 11 in the −Z direction is securely joined to the first conductor portion 13, and the end of the second resonant element 12 in the +Z direction is securely joined to the second conductor portion 14.

Moreover, in the resonator according to this embodiment, the second resonant element 12 is cylindrically shaped. Thus, since the first resonant element 11 can be surrounded by a single second resonant element 12 of simple configuration at a distance therefrom, greater mass-producibility of the resonator is achieved.

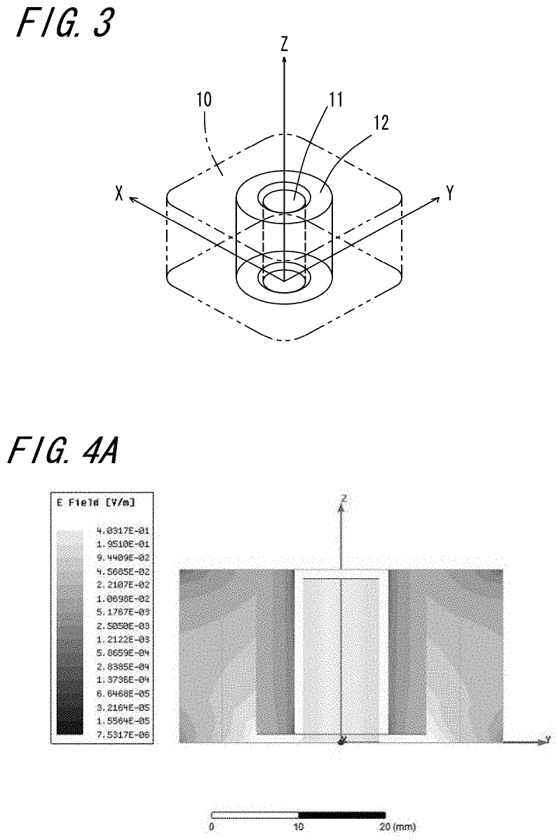

FIG. 3 is a perspective view showing a numerical analytical model for simulation of the resonator according to the first embodiment. FIG. 4A is a view showing an electric field distribution obtained from analysis on the numerical analytical model for simulation of the resonator according to the first embodiment. FIG. 4B is a view showing a magnetic field distribution obtained from analysis on the numerical analytical model for simulation of the resonator according to the first embodiment. The inventors of the invention performed analysis of the electric characteristics and magnetic characteristics of the resonator according to the first embodiment shown in FIGS. 1 and 2. In numerical analysis work by computer simulation, the through holes 16 and 17 were omitted from the resonator.

Simulation conditions set for the numerical analytical model were as follows: the dielectric constituting the second resonant element 12 had a relative permittivity of 43 and a dielectric loss tangent of 3×10⁻⁵; the first conductor portion 13, the second conductor portion 14, and the first resonant element 11 each had an electrical conductivity of 4.2×10⁷ S/m; the cavity 19 had a dimension of 38 mm in a positive direction along the X axis (+X direction) and in a positive direction along the Y axis (+Y direction); the cavity 19 had a dimension of 20 mm in the +Z direction; the first resonant element 11 was set to 9 mm in diameter; the first resonant element 11 was set to 19 mm in length (dimension in the +Z direction); the second resonant element 12 was set to 11 mm in inside diameter; the second resonant element 12 was set to 20 mm in outside diameter; and the second resonant element 12 was set to 19 mm in length (dimension in the +Z direction). The numerical analytical model had the inner wall-covering layer 3 and the end wall-covering layer 4, but had no outer wall-covering layer 6. The inner wall-covering layer 3 and the end wall-covering layer 4 were each set to 10 μm in thickness.

The simulation showed that: the resonant frequency of fundamental-mode resonance was 670 MHz; the Q value of fundamental-mode resonance was 2952; the resonant frequency of higher order-mode resonance with the lowest frequency was 2.74 GHz; and the resonant frequency of higher order-mode resonance was 2.95 GHz. Note that the higher-order mode does not refer to one of the even and odd modes under the principle of resonant mode concerned but refers to a mode corresponding to the dielectric. It will be seen from the analytical results that the construction according to the disclosure is higher in terms of higher-order mode level than typical dielectric resonators due to the small volume of the dielectric.

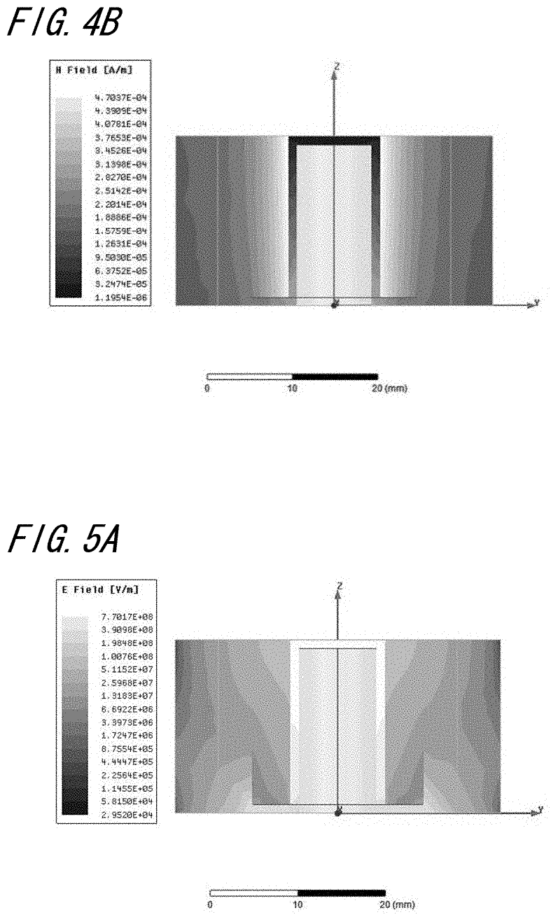

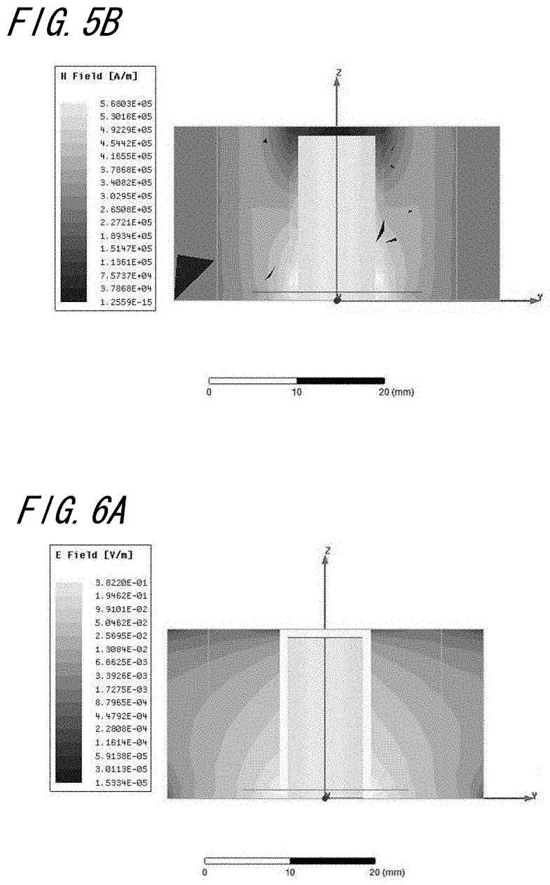

FIG. 5A is a view showing an electric field distribution obtained from numerical analysis of the electric field-magnetic field characteristics of a numerical analytical model for simulation of a resonator according to Comparative example 1 intended to represent a covered conductor-free resonator including the second resonant element 12 with the inner wall-covering layer 3 and the end wall-covering layer 4 removed. FIG. 5B is a view showing a magnetic field distribution obtained from numerical analysis of the electric field-magnetic field characteristics of the numerical analytical model of the resonator according to Comparative example 1. Numerical analysis work was performed with the numerical analytical model of the resonator according to Comparative example 1 intended to represent a resonator which was identical in dimensions and physical properties with the resonator according to the first embodiment but differed from the resonator according to the first embodiment in that the second resonant element 12 has neither of the inner wall-covering layer 3 and the end wall-covering layer 4.

The numerical analysis on Comparative example 1 showed that: the resonant frequency of fundamental-mode resonance was 1.05 GHz; the Q value of fundamental-mode resonance was 3828; the resonant frequency of higher order-mode resonance was 2.63 GHz; and the Q value of higher order-mode resonance with the lowest frequency was 2612.

It will be seen from the analytical results that the resonator according to Comparative example 1, while being equivalent to a conventional quarter-wavelength semi-coaxial resonator in terms of magnetic field distribution, is higher than the resonator according to the first embodiment in respect of electric field distribution, that is; both of the resonant frequency of fundamental-mode resonance and the resonant frequency of higher order-mode resonance of Comparative example 1, while being lower than those of the conventional resonator, are higher than those of the first embodiment. As a matter of course, in order to decrease frequency, an increase in resonator size is necessary.

FIG. 6A is a view showing an electric field distribution obtained from numerical analysis of the electric field-magnetic field characteristics of a numerical analytical model for simulation of a resonator according to Comparative example 2 intended to represent a resonator including the second resonant element 12 whose dielectric is air, and which includes the inner wall-covering layer 3 on the inner surface thereof. FIG. 6B is a view showing a magnetic field distribution obtained from numerical analysis of the electric field-magnetic field characteristics of the numerical analytical model of the resonator according to Comparative example 2. Numerical analysis work was performed with the numerical analytical model of the resonator according to Comparative example 2 intended to represent a resonator which was identical in dimensions with the resonator according to the first embodiment but differed from the resonator according to the first embodiment in that the second resonant element 12 is not provided with the end wall-covering layer 4.

The numerical analysis on Comparative example 2 showed that: the resonant frequency of fundamental-mode resonance was 0.81 GHz; the Q value of fundamental-mode resonance was 3206; the resonant frequency of higher order-mode resonance with the lowest frequency was 7.88 GHz; and the Q value of higher order-mode resonance was 4244.

It will be seen from the analytical results that the resonator according to Comparative example 2, though greater in respect of intermetallic magnetic-field distribution, basically possesses the characteristics of magnetic field distribution of the resonator according to the first embodiment, and yet exhibit higher resonant frequency of fundamental-mode resonance and higher resonant frequency of higher order-mode resonance.

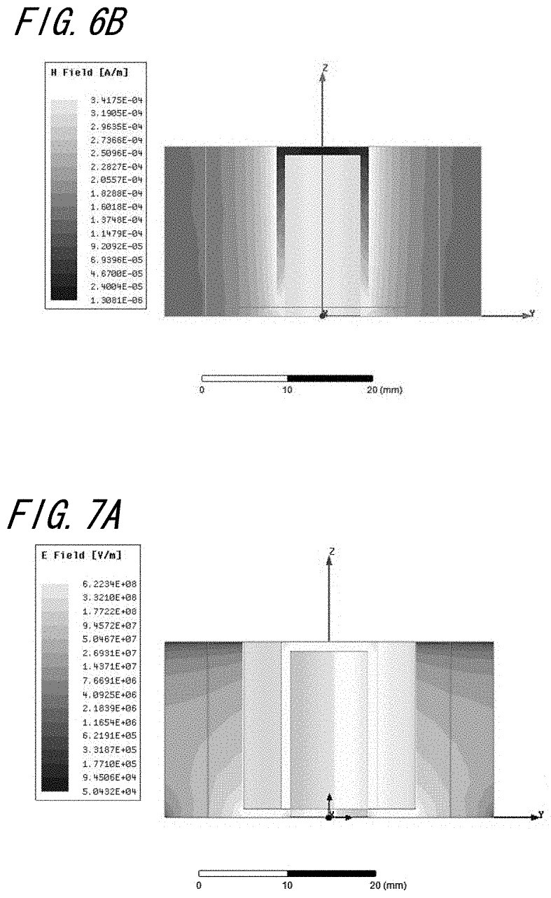

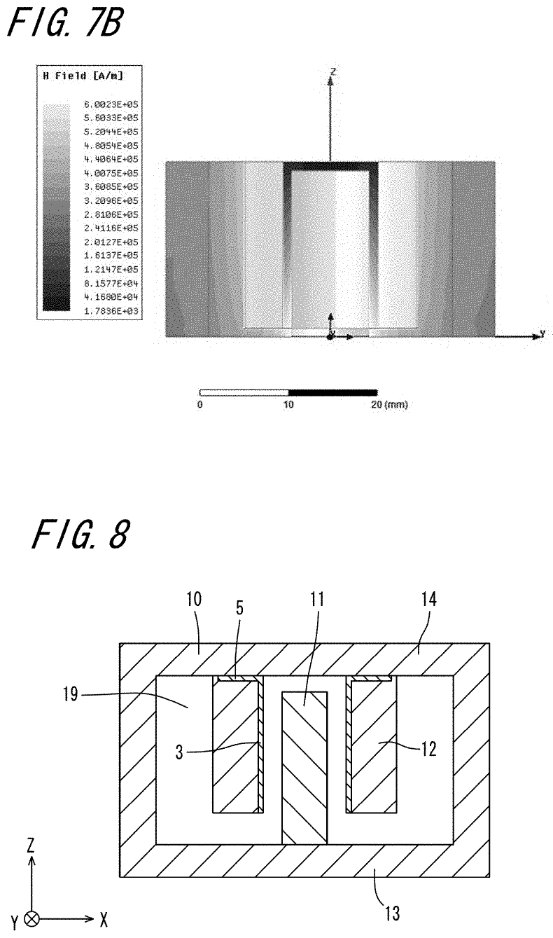

FIG. 7A is a view showing an electric field distribution obtained from numerical analysis of the electric field-magnetic field characteristics of a numerical analytical model for simulation of a resonator according to Comparative example 3 intended to represent a resonator including the second resonant element 12 whose dielectric is a metal, with the inner wall-covering layer 3 and the end wall-covering layer 4 removed. FIG. 7B is a view showing a magnetic field distribution obtained from numerical analysis of the electric field-magnetic field characteristics of the numerical analytical model of the resonator according to Comparative example 3. For calculation of electric field-magnetic field characteristics, numerical analysis work was performed with the numerical analytical model of the resonator according to Comparative example 3 intended to represent a resonator which differed from the numerical analytical model of the resonator according to the first embodiment in that the dielectric of the second resonant element 12 was metal and the end wall-covering layer 4 was removed, and was otherwise identical with the numerical analytical model of the resonator according to the first embodiment.

The numerical analysis on Comparative example 3 showed that: the resonant frequency of fundamental-mode resonance was 0.95 GHz; the Q value of fundamental-mode resonance was 1902; the resonant frequency of higher order-mode resonance with the lowest frequency was 6.74 GHz; and the Q value of higher order-mode resonance was 1459.

It will be seen from the analytical results that the resonator according to Comparative example 3 exhibits a lower Q value due to an increase in magnetic field level between conductors and the absence of magnetic field around the conductors, and exhibits higher resonant frequency of fundamental-mode resonance and higher resonant frequency of higher order-mode resonance.

### Second Embodiment

FIG. 8 is a sectional view schematically showing a resonator according to a second embodiment of the invention. In this embodiment, like parts are identified by the same reference symbols as in the preceding embodiment. The resonator according to this embodiment includes a second resonant element 12 which includes, like the second resonant element 12 of the first embodiment, the inner wall-covering layer 3, but includes no end wall-covering layer 4. Otherwise, the resonator according to this embodiment is structurally similar to that of the first embodiment.

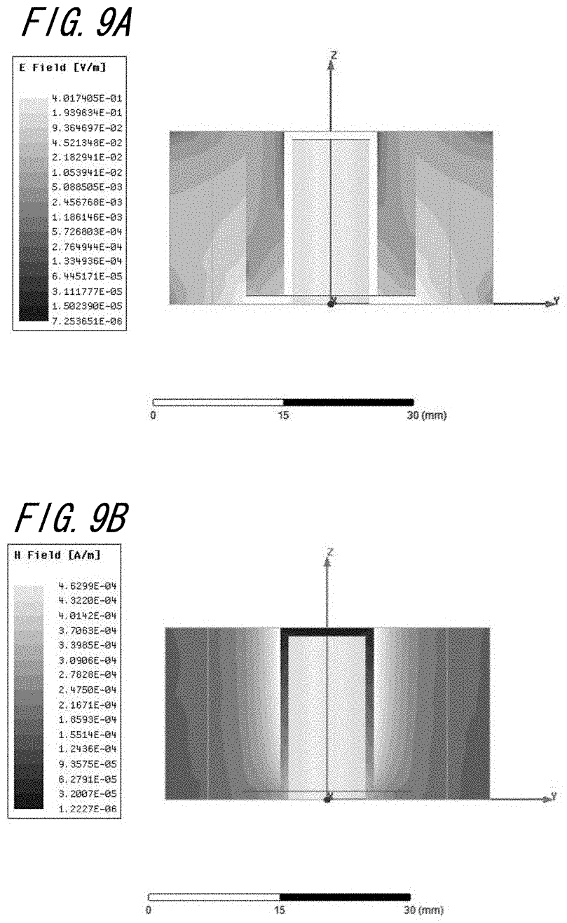

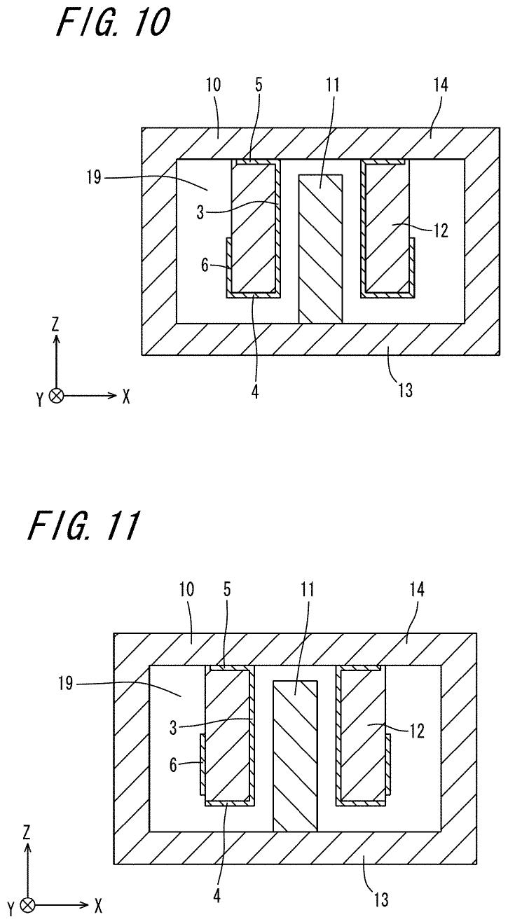

FIG. 9A is a view showing an electric field distribution obtained from analysis on a numerical analytical model for simulation of the resonator according to the second embodiment. FIG. 9B is a view showing a magnetic field distribution obtained from analysis on the numerical analytical model of the resonator according to the second embodiment. The numerical analysis on the resonator according to the second embodiment showed that: the resonant frequency of fundamental-mode resonance was 0.72 GHz; the Q value of fundamental-mode resonance was 2987; the resonant frequency of higher order-mode resonance with the lowest frequency was 2.92 GHz; and the Q value of higher order-mode resonance was 2071.

It will be seen from the analytical results that, in respect of electric field distribution, an increase in electric field intensity at the end of the second resonant element 12 in the −Z direction which is the first direction resulted in a decrease in frequency, and, in respect of magnetic field distribution, a decrease in electric field intensity at the end of the second resonant element 12 in the −Z direction, in particular, a decrease in inter-conductor electric field intensity between the first resonant element 11 and the inner wall-covering layer 3, resulted in a higher Q.

### Third Embodiment

FIG. 10 is a sectional view schematically showing a resonator according to a third embodiment of the invention. In this embodiment, like parts are identified by the same reference symbols as in the preceding embodiments. The resonator according to this embodiment includes a second resonant element 12 which includes the inner wall-covering layer 3, the end wall-covering layer 4, and the junction end-covering layer 5 as in the second resonant element 12 of the first embodiment, and additionally includes an outer wall-covering layer 6 configured so as to cover about one-half of the entire outer wall of the second resonant element 12 while extending from the end in the −Z direction toward the end in the +Z direction. Otherwise, the resonator according to this embodiment is structurally similar to those of the preceding embodiments.

### Fourth Embodiment

FIG. 11 is a sectional view schematically showing a resonator according to a fourth embodiment of the invention. In this embodiment, like parts are identified by the same reference symbols as in the preceding embodiments. The resonator according to this embodiment is structurally similar to the resonator according to the third embodiment, but differs from the resonator according to the third embodiment in that the location of the outer wall-covering layer 6 is shifted toward the end in the +Z direction.

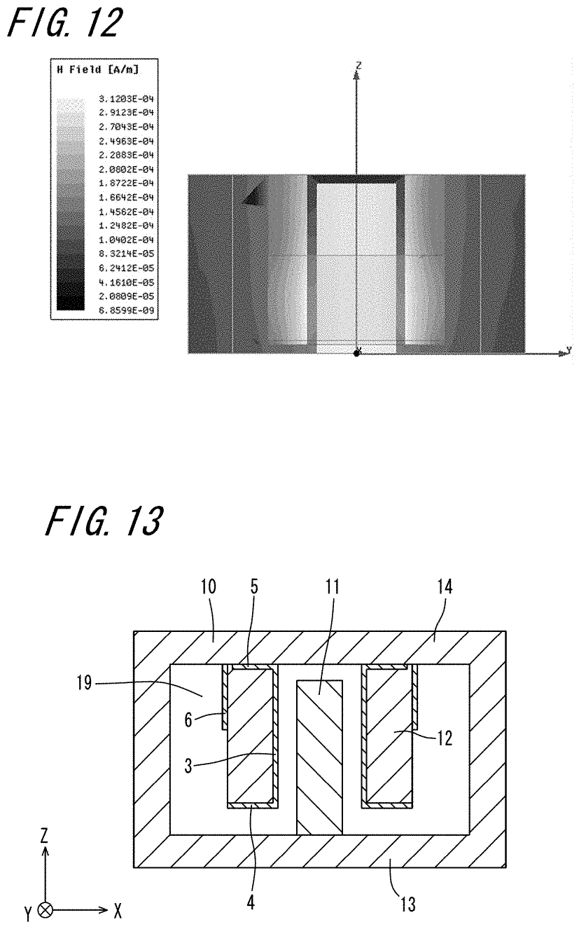

FIG. 12 is a view showing a magnetic field distribution obtained from analysis on a numerical analytical model for simulation of the resonator according to the fourth embodiment. In this embodiment, like parts are identified by the same reference symbols as in the preceding embodiments. The numerical analysis on the resonator according to the fourth embodiment showed that: the resonant frequency of fundamental-mode resonance was 0.68 GHz; the Q value of fundamental-mode resonance was 2824; the resonant frequency of higher order-mode resonance with the lowest frequency was 1.01 GHz; and the Q value of higher order-mode resonance was 278.

It will be seen from the analytical results that, as compared with the resonator according to the third embodiment, the resonator according to the fourth embodiment exhibits further decrease in frequency with no significant lowering in Q value.

### Fifth Embodiment

FIG. 13 is a sectional view schematically showing a resonator according to a fifth embodiment of the invention. In this embodiment, like parts are identified by the same reference symbols as in the preceding embodiments. The resonator according to this embodiment is structurally similar to the resonator according to the fourth embodiment, but differs from the resonator according to the fourth embodiment in that, in addition to the inner wall-covering layer 3, the end wall-covering layer 4, and the junction end-covering layer 5, there is provided an outer wall-covering layer 6 configured so as to cover about one-half of the entire outer wall of the second resonant element while extending from the end in the +Z direction toward the end in the −Z direction. Otherwise, the resonator according to this embodiment is structurally similar to that of the fourth embodiment.

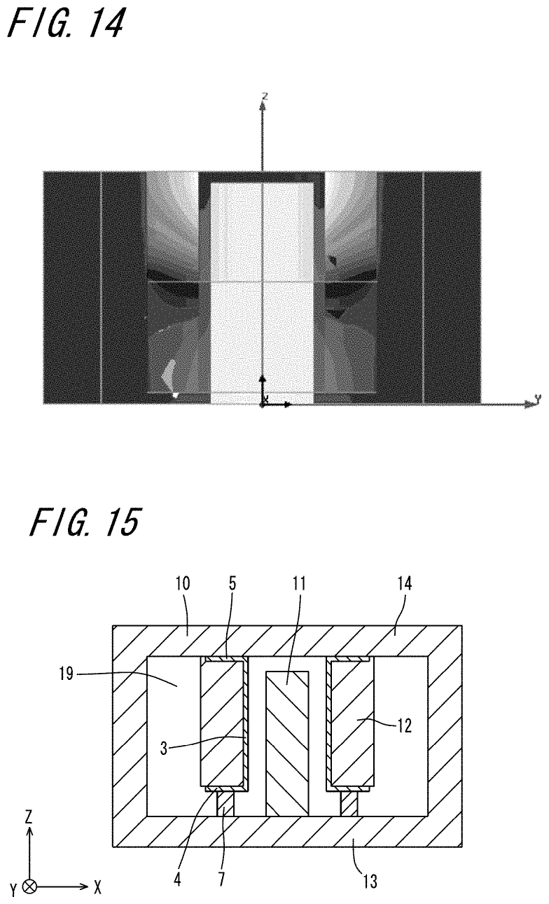

FIG. 14 is a view showing a magnetic field distribution obtained from analysis on a numerical analytical model for simulation of the resonator according to the fifth embodiment. The numerical analysis on the resonator according to the fifth embodiment showed that: the resonant frequency of fundamental-mode resonance was 0.64 GHz; the Q value of fundamental-mode resonance was 2115; the resonant frequency of higher order-mode resonance with the lowest frequency was 1.47 GHz; and the Q value of higher order-mode resonance was 1128.

It will be seen from the analytical results that, as compared with the resonator according to the fourth embodiment, the resonator according to the fifth embodiment exhibits further decrease in frequency, and, though lower in Q value, undergoes no significant lowering in Q value.

### Sixth Embodiment

FIG. 15 is a sectional view schematically showing a resonator according to a sixth embodiment of the invention. In this embodiment, like parts are identified by the same reference symbols as in the preceding embodiments. The resonator according to this embodiment includes: a shield housing 10 including a first conductor portion 13 located on a side of −Z direction which is a first direction, and a second conductor portion 14 located on a side +Z direction which is opposite to the −Z direction, the shield housing 10 having a cavity 19 therein; a first resonant element 11 which is formed of a dielectric or conductor, has a columnar shape, lies within the cavity 19, and includes an end in the −Z direction joined to the first conductor portion 13, and the other end in the +Z direction spaced from the shield housing 10 by a distance 51; and a second resonant element 12 which lies within the cavity 19, includes an end in the +Z direction joined to the second conductor portion 14 and the other end in the −Z direction spaced from the shield housing 10 by a distance 53, and surrounds the first resonant element 11 at a distance 52 from the first resonant element 11.

The second resonant element 12 includes: a conductor-made inner wall-covering layer 3 located on an inner wall surface thereof; a conductor-made end wall-covering layer 4 located on an end in the −Z direction; and a conductor-made junction end-covering layer 5 located on an end in the +Z direction. In a region corresponding to the distance 53 between the first conductor portion 13 and the end of the second resonant element 12 in the −Z direction, a support portion 7 formed of a low-permittivity dielectric is located. The support portion 7 may be shaped in a short cylinder defined by a plurality of equiangularly spaced-apart pieces.

The placement of such a support portion 7 permits pressure bonding of the second resonant element 12 for bringing the second resonant element 12 into conduction. In this case, the support portion 7 may be made of a low-loss and somewhat deformable material such as polytetrafluoroethylene.

### Seventh Embodiment

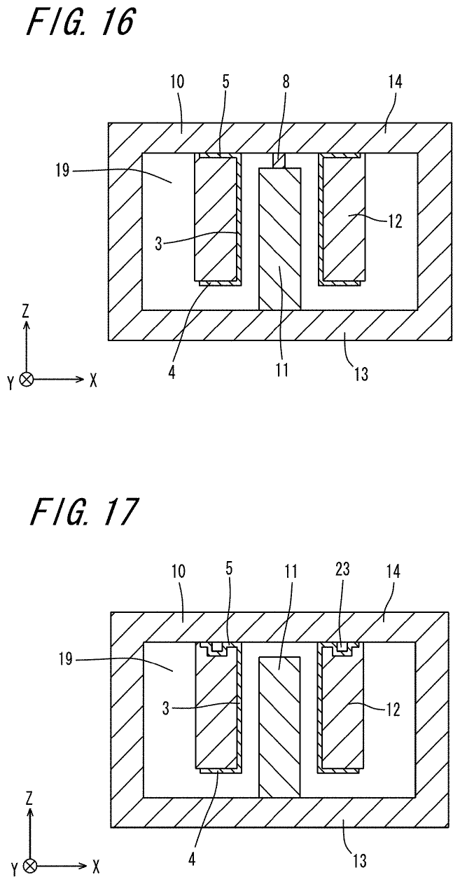

FIG. 16 is a sectional view schematically showing a resonator according to a seventh embodiment of the invention. The resonator according to this embodiment is similar to the resonator according to the sixth embodiment. In this embodiment, like parts are identified by the same reference symbols as in the sixth embodiment. The resonator according to this embodiment includes the shield housing 10, the first resonant element 11, and the second resonant element 12. Moreover, in a region between the second conductor portion 14 and the end of the first resonant element 11 in the +Z direction, a hold-down portion 8 made of a dielectric is provided. For example, the hold-down portion 8 is built as a short cylindrical piece.

The placement of such a hold-down portion 8 enables further decrease in resonant frequency. The hold-down portion 8 may be made of a low-loss material such as ceramic or polytetrafluoroethylene.

### Eighth Embodiment

FIG. 17 is a sectional view schematically showing a resonator according to an eighth embodiment of the invention. The resonator according to this embodiment is similar to the resonator according to the sixth embodiment. In this embodiment, like parts are identified by the same reference symbols as in the sixth embodiment. The resonator according to this embodiment includes the shield housing 10, the first resonant element 11, and the second resonant element 12. Moreover, the second resonant element 12 is provided, in a region located between the junction end-covering layer 5 located on the end in the +Z direction and the second conductor 14, with an annular recess portion 23 which serves as a solder receiver for receiving a flow of solder constituting part of the junction end-covering layer 5. Note that the recess portion may be formed in the corresponding region of the shield housing 10 instead.

The placement of such a recess portion 23 can restrain solder from spreading out of the conductor coating film, and thereby prevent changes in the area of the conductor. As a rule, a similar effect can be attained by setting overcoat glass in a location other than a junction on the conductor coating film.

### Ninth Embodiment

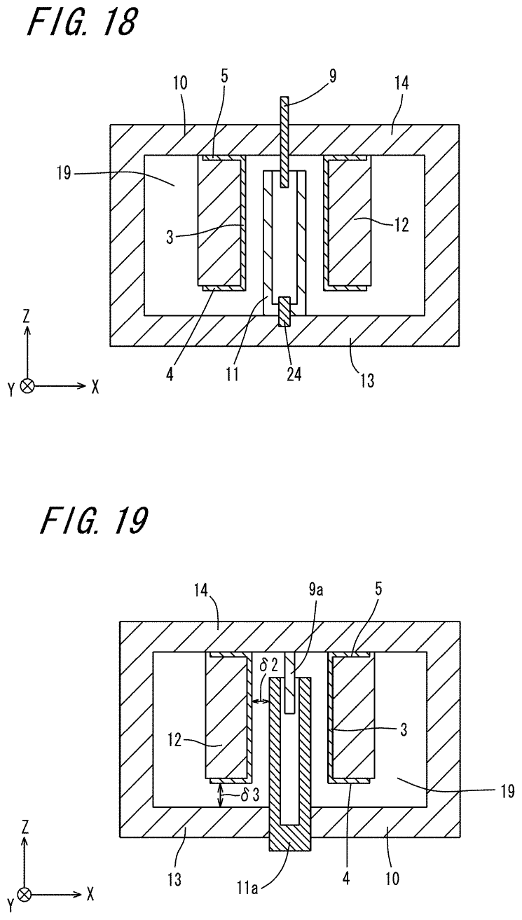

FIG. 18 is a sectional view schematically showing a resonator according to a ninth embodiment of the invention. The resonator according to this embodiment is similar to the resonator according to the sixth embodiment. In this embodiment, like parts are identified by the same reference symbols as in the sixth embodiment. The resonator according to this embodiment includes the shield housing 10, the first resonant element 11, and the second resonant element 12, and further includes a frequency adjuster 9 formed of a conductor, is located in the second conductor portion 14, and carries out frequency adjustment by varying an overlap amount of the adjuster and the first resonant element 11 in the −Z direction or the +Z direction. The first resonant element 11 is shaped in a bottomed cylinder which opens in the +Z direction. The frequency adjuster 9 is loosely fitted in the central hole of the first resonant element 11 so as to be movable. The bottom of the first resonant element 11 is secured to the first conductor portion 13 via a screw member 24.

For example, such a frequency adjuster 9 is built as a metallic bolt. Resonant frequency adjustment is carried out by allowing the frequency adjuster 9 to threadedly advance and retract with respect to the second conductor portion 14.

### Tenth Embodiment

FIG. 19 is a sectional view schematically showing a resonator according to a tenth embodiment of the invention. In this embodiment, like parts are identified by the same reference symbols as in the preceding embodiments. The resonator according to this embodiment includes: a shield housing 10 including a first conductor portion 13 located on a side of −Z direction which is a first direction, and a second conductor portion 14 located on a side of +Z direction which is opposite to the −Z direction, the shield housing 10 having a cavity 19 therein; a first resonant element 11a which is formed of a dielectric or conductor, has a columnar shape, lies within the cavity 19, and includes an end in the −Z direction joined to the first conductor portion 13; and a second resonant element 12 which lies within the cavity 19, includes an end in the +Z direction joined to the first conductor portion 14 and the other end in the −Z direction spaced from the first conductor portion 13 of the shield housing 10 by a distance 53, and surrounds the first resonant element 11 at a distance 52 from the first resonant element 11.

The resonator according to this embodiment further includes a conductor-made frequency adjuster 9a located in the second conductor portion 14. The first resonant element 11a is shaped in a bottomed cylinder which opens in the +Z direction. The frequency adjuster 9a is loosely fitted in the central hole of the first resonant element 11 so as to be movable. The first resonant element 11a passes threadedly through the first conductor portion 13 in a thickness direction parallel to the −Z direction and the +Z direction. Resonant frequency adjustment is carried out by varying an overlap amount of the frequency adjuster 9a and the first resonant element 11a.

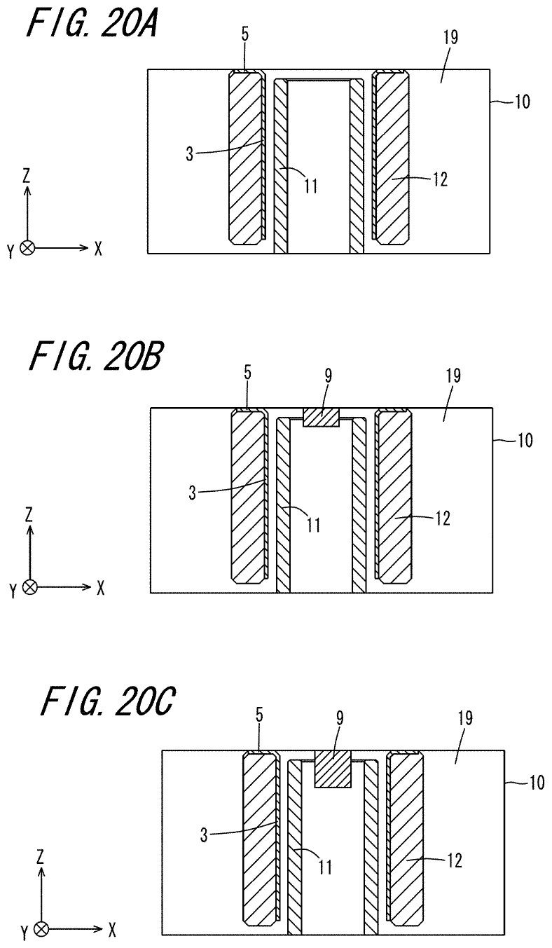

FIGS. 20A to 20C are each an explanatory diagram illustrating variation in frequency caused by operation of the frequency adjuster. FIG. 20A is a sectional view schematically showing a resonator free of the frequency adjuster 9. FIG. 20B shows a condition where the frequency adjuster 9 protrudes by 2 mm into the cavity 19 from the second conductor portion 14. FIG. 20C shows a condition where the frequency adjuster 9 protrudes by 4 mm into the cavity 19 from the second conductor portion 14.

In this way, the frequency adjuster 9 was inserted into the cavity 19 with varying protruding amounts. At the protruding amount of 2 mm, the resonant frequency varied by 0.007 GHz. At the protruding amount of 4 mm, the resonant frequency varied by 0.014 GHz. It will thus be seen that the resonant frequency can be adjusted by varying the protruding amount of the frequency adjuster 9 exposedly inserted in the cavity 19.

### Eleventh Embodiment

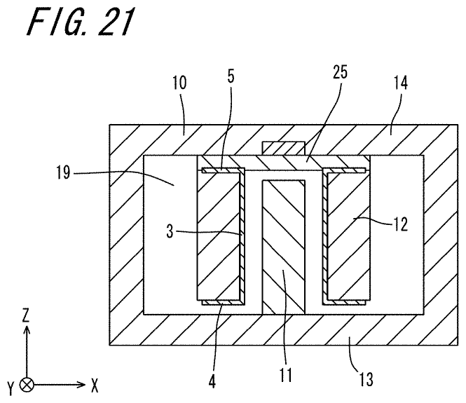

FIG. 21 is a sectional view schematically showing a resonator according to an eleventh embodiment of the invention. In this embodiment, like parts are identified by the same reference symbols as in the preceding embodiments. The resonator according to this embodiment includes a base portion 25 made of a metal serving as a conductor, which is located between the end of the second resonant element 12 in the +Z direction and the second conductor portion 14.

Such a configuration permits connection of the dielectric to the base portion 25 in advance. The use of the base portion 25 which is sufficiently small relative to the size of resonator housing facilitates heat application during solder connection.

(Filter)

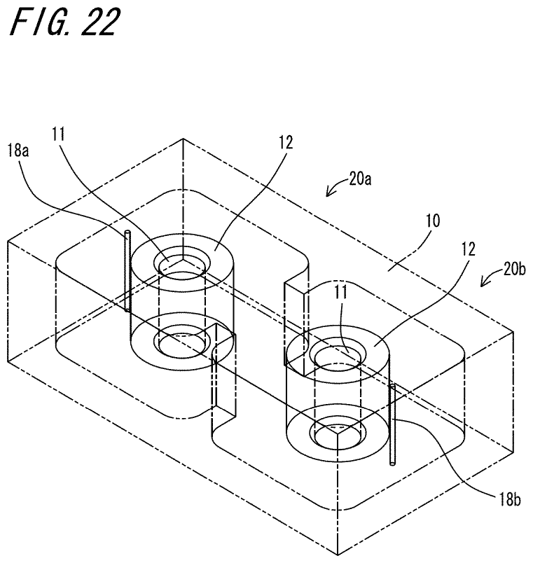

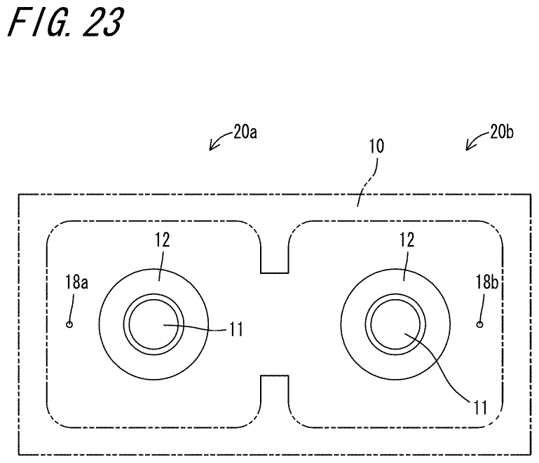

FIG. 22 is a perspective view schematically showing one embodiment of a filter according to the invention. FIG. 23 is a sectional view of the filter shown in FIG. 22. The filter according to this embodiment includes: a plurality of resonators, namely a first resonator 20a and a second resonator 20b; a first terminal portion 18a; and a second terminal portion 18b. The first resonator 20a and the second resonator 20b are each structurally identical with the resonators shown in FIGS. 1 to 21. Moreover, the first resonator 20a and the second resonator 20b are aligned in a row so as to be electromagnetically coupled to each other. The first resonator 20a is located at one end of the row, and the second resonator 20b is located at the other end of the row. The first terminal portion 28a is electromagnetically connected to the first resonator 20a, and the second terminal portion 28b is electromagnetically connected to the second resonator 20b. Thus constructed, the filter according to this embodiment is compact and has excellent characteristics accruing from little insertion loss in a pass band and high attenuation in the vicinity of the pass band.

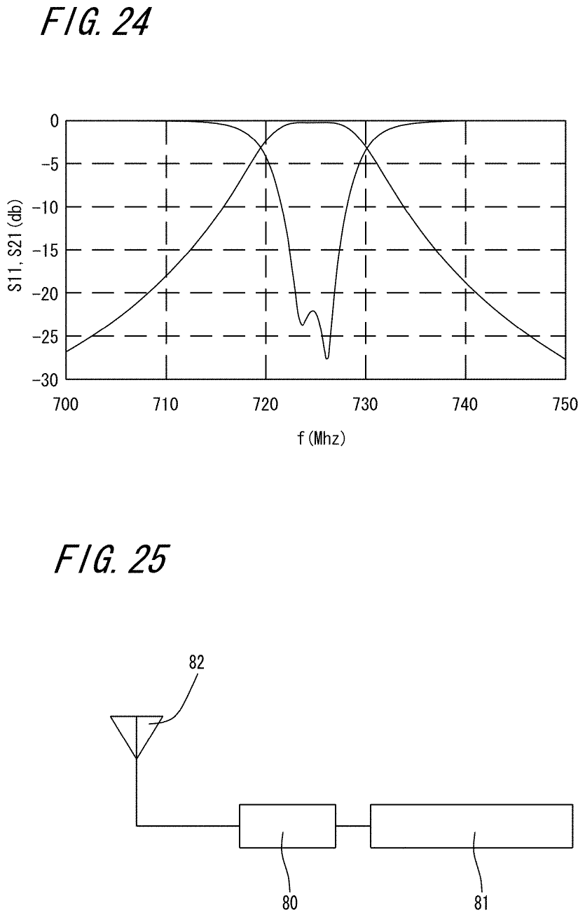

FIG. 24 is a graph indicating the frequency characteristics of a filter incorporating the resonator according to the second embodiment as the first resonator 20a and the second resonator 20b as well. It will be seen from the graph that the filter has satisfactory filter characteristics, i.e. improved transmission characteristics S21 and also high reflection characteristics S11 of −20 dB or below at 725 MHz. This proves that the resonator according to the disclosure lends itself to use for filters.

FIG. 25 is a block diagram schematically showing one embodiment of a communication device according to the invention. The communication device according to this embodiment includes: an antenna 82; a communication circuit 81; and a filter 80 connected to the antenna 82 and the communication circuit 81. The filter 80 is the filter according to the one embodiment mentioned above. Each of the antenna 82 and the communication circuit 81 is of known conventional design.

Thus constructed, the communication device according to this embodiment removes unnecessary electric signals with the compact filter having excellent electrical characteristics, the use of which permits downsizing of the communication device and enables the communication device to perform excellent communication quality.

It should be understood that the application of the invention is not limited to the embodiments described heretofore, and that various changes, modifications, and improvements are possible in accordance with the technical ideas of the invention.

For example, while the foregoing embodiments have been described with respect to the case where the first resonant element 11 is shaped in a circular cylinder, the shape of the first resonant element 11 is not limited to this. For example, the first resonant element 11 may be shaped in a rectangular prism, a hexagonal prism, or an elliptical column. Moreover, as in the resonator described in Patent Literature 1, the first resonant element 11 may be made with varying cross-sectional area.

Moreover, while the foregoing embodiments have been described with respect to the case where a single cylindrical second resonant element 12 surrounds the first resonant element 11, the arrangement of the second resonant element 12 is not limited to this. For example, the second resonant element 12 may be provided with slits extending in the +Z direction so that it can be divided into four pieces. That is, a plurality of second resonant elements 12 may be arranged so as to surround the columnar element 21.

Moreover, while the filter according to the one embodiment has been illustrated as incorporating the first resonator 20a and the second resonator 20b that are each structurally identical with the resonator according to the second embodiment, the resonator structure is not limited to this. For example, the first and second resonators 20a and 20b may have the same structure as that of the resonator according to the first embodiment or any one of the third to thirteenth embodiments, or may have other structure.

Moreover, while the foregoing embodiments have been described with respect to the case where the filter includes two resonators, namely the resonator 20a and the resonator 20b, the filter construction is not limited to this. The filter may include three or more resonators. In this case, an additional resonator or additional resonators are placed between the first resonator 20a and the second resonator 20b, and all the resonators are electromagnetically coupled to one another. Moreover, in conformance with conventional filter design, an attenuation pole may be formed by cross-coupling of non-adjacent resonators.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### REFERENCE SIGNS LIST

3: Inner wall-covering layer

4: End wall-covering layer

5: Junction end-covering layer

6: Outer wall-covering layer

7: Support portion

8: Hold-down portion

9: Frequency adjuster

10: Shield housing

11: First resonant element

12: Second resonant element

13: First conductor portion

14: Second conductor portion

18a: First terminal portion

18b: Second terminal portion

19: Cavity

20a: First resonator

20b: Second resonator

1. A resonator, comprising:
a shield housing comprising a first conductor portion located on a first direction side, and a second conductor portion located on a second direction side which is opposite to the first direction side, the shield housing having a cavity therein;
a first resonant element which is shaped in a column and lies within the cavity, the first resonant element comprising a first direction end joined to the first conductor portion, and a second direction end spaced from the shield housing;
a second resonant element which is constituted by a tubular dielectric and lies within the cavity, the second resonant element comprising a second direction end joined to the second conductor portion and a first direction end spaced from the shield housing, and surrounding the first resonant element at a distance from the first resonant element; and
an inner wall-covering layer formed of a conductor, the inner wall-covering layer being located on an inner wall surface of the second resonant element.

2. The resonator according to claim 1, further comprising:
an end wall-covering layer formed of a conductor, the end wall-covering layer being located on the first direction end of the second resonant element.

3. The resonator according to claim 1, further comprising:
an outer wall-covering layer formed of a conductor, the outer wall-covering layer being located on an outer wall surface of the second resonant element.

4. The resonator according to claim 1, further comprising:
a support portion formed of a dielectric, the support portion being located between the first conductor portion and the first direction end of the second resonant element.

5. The resonator according to claim 1, further comprising:
a hold-down portion formed of a dielectric, the hold-down portion being located between the second conductor portion and the second direction end of the first resonant element.

6. The resonator according to claim 1, further comprising:
a frequency adjuster formed of a conductor, the frequency adjuster being located in the first conductor portion, and carrying out frequency adjustment by varying an overlap amount of the frequency adjuster and the first resonant element in a first direction or a second direction.

7. A filter, comprising:
first and second resonators, each comprising the resonator according to claim 1;
a first terminal portion electrically or electromagnetically connected to the first resonator; and
a second terminal portion electrically or electromagnetically connected to the second resonator.

8. A communication device, comprising:
an antenna;
a communication circuit; and
a filter according to claim 7 connected to the antenna and the communication circuit.
